(19) United States
(12) Patent Application Publication
(10) Pub. No.: US 2004/0036901 A1
(43) Pub. Date: Feb. 26, 2004

(54) System and method for using multiple settings for processing a document with an image processing apparatus

(75) Inventor: Naomi Nakane, Yokohama-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/224,344

(22) Filed: Aug. 21, 2002

(51) Int. Cl. G06F 3/12; H04N 1/41

(52) U.S. Cl. 358/1.13; 358/426.02; 358/501

(57) ABSTRACT

A system and method for processing a plurality of pages comprises receiving a selection of default settings for scanning the plurality of pages, identifying at least one of the plurality of pages for special settings, and designating the special settings for each of the at least one identified pages. Each of the at least one identified pages is scanned according to the designated special settings and scanning each of the plurality of pages other than the at least one identified pages according to the default settings.

### FIELD OF THE INVENTION

The present invention relates generally to image processing, and more particularly to a system and method for specialized copying, scanning and compression of images.

### BACKGROUND OF THE INVENTION

Digital copiers have become increasingly prevalent and competitive with analog copiers. Digital copiers provide users with the ability to make copies of documents in various settings. However, when a plurality of sheets of a draft are copied by a digital copier using an automatic document feeder (ADF) or similar device, the copying can only be carried out in one kind of setting or mode that is initially set from a computer panel, even if more than one setting is desired.

If the document includes a plurality of sheets, and the setting is different for at least one of the pages of the document, such as contracting a particular page, the user is obliged to perform the copying of the particular page separately from the other pages. In particular, to perform the contraction or other specialized setting of the particular page of the document, the user must place that page by hand on the copier without using the ADF and enter the setting from a computer panel.

Digital copiers typically have the ability to determine whether a document is in color or monochrome based on pre-scanning information. This process is referred to as auto color select (ACS). The ACS process becomes less efficient if only one or two sheets of a plurality of sheets of the document to be copied are in color because the content of all of the pages are prescanned to determine the color/monochrome content of each page.

As part of the copying process for a digital copier, the document being copied is scanned to create a digital input image. The input image, which includes each of the pages of the document, may be stored in a memory, and the input image stored in the memory may be subject to a compression algorithm. The compressed image may then be stored in a non-volatile memory, such as a hard disk drive. Similar to the limitation on the copy settings applied to particular sheets of a document, only one type of compression algorithm can be used for the input image. Due to this limitation, an optimum processing cannot be executed for a document, which can result in poorer image quality and require increased memory space to store the compressed input image.

### SUMMARY OF THE INVENTION

Briefly, in one aspect of the invention, a method for processing a plurality of pages comprises receiving a selection of default settings for scanning the plurality of pages, identifying at least one of the plurality of pages for special settings, and designating the special settings for each of the at least one identified pages. Each of the at least one identified pages is scanned according to the designated special settings and scanning each of the plurality of pages other than the at least one identified pages according to the default settings.

In another aspect of the present invention, each of the scanned pages is compressed with a compression algorithm in accordance with the special settings or default settings for that scanned page, wherein the compression algorithm is different for the special settings and the default settings.

In yet another aspect of the present invention, a first compression algorithm is used if the special or default settings indicate the page is in color and a second compression algorithm different from the first compression algorithm is used if the special or default settings indicate the page is in black and white.

### BRIEF DESCRIPTION OF THE DRAWINGS

FIG. 1 shows a block diagram of an image forming apparatus consistent with the present invention.

FIG. 2 is a block diagram of a control system for the image forming apparatus of FIG. 1.

FIG. 3 is a flow diagram for a control process consistent with the present invention.

FIG. 4 is a block diagram of an image processing system consistent with the present invention.

FIG. 5 is a flow diagram of an image process for the image processing system of FIG. 4.

FIG. 6 is a flow diagram for compressing scanned images consistent with the present invention.

### DETAILED DESCRIPTION OF THE PREFERRED EMBODIMENT

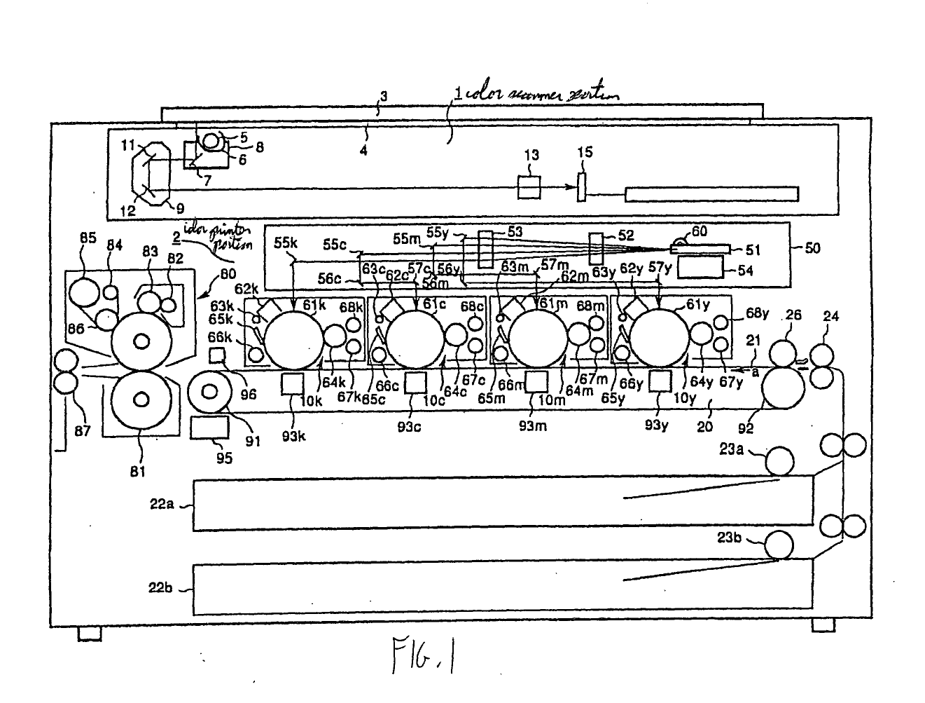

FIG. 1 shows a block diagram of an image forming apparatus consistent with the present invention. The image forming apparatus may be a hardcopy device such as a digital type color copier for forming a copied image of a color image. As shown in FIG. 1, the image forming apparatus includes a color scanner portion 1, which scans and reads a color image on a document and a color printer portion 2, which forms a copied image of the color image.

The color scanner portion 1 includes a document base cover 3 at an upper portion thereof. A document base 4 is arranged opposite to the document base cover 3 in a closed state and includes transparent glass on which the document is set. On a lower side of the document base 4 are arranged an exposure lamp 5 for illuminating the document mounted on the document base 4, a reflector 6 for focusing light from the exposure lamp 5 to the document and a first mirror 7 for reflecting the light from the document. The exposure lamp 5, the reflector 6 and the first mirror 7 are fixed to a first carriage 8. The first carriage 8 is moved by a pulse motor, not illustrated, along a lower face of the document base 4.

A second carriage 9 is arranged in a direction in which the light is reflected by the first mirror 7 and provided movably in parallel with the document base 4 via a drive mechanism, such as a belt with teeth in conjunction with a direct current motor or the like. The second carriage 9 includes a second mirror 11 for reflecting the light from the first mirror 7 to a third mirror 12. The third mirror 12 then reflects the light from the second mirror 11. The second carriage 9 is driven by the first carriage 8 and is moved along the document base 4 in parallel therewith at half the speed of the first carriage 8.

A focusing lens 13 focuses the light reflected from the third mirror 12 by a predetermined magnification. A CCD type color image sensor or photoelectric conversion element 15 converts the reflected light focused by the focusing lens 13 into an electric signal.

When light from the exposure lamp 5 is focused on the document on the document base 4 by the reflector 6, the reflected light from the document is made to be incident on the color image sensor 15 via the first mirror 7, the second mirror 11, the third mirror 12 and the focusing lens 13. At the color image sensor 15, the incident light is converted into an electric signal in accordance with the three primary colors of light of R (red), G (green) and B (blue).

The color printer portion 2 includes first through fourth image forming portions 10y, 10m, 10c and 10k. These image forming portions form images that are subjected to color decomposition for respective color components. In particular, the images are decomposed into the four colors of yellow (y), magenta (m), cyan (c) and black (k) according to known decomposition methods, such as the subtractive mixing method.

A transfer mechanism 20, which includes a transfer belt 21, transfers the images of the respective colors formed by the respective image forming portions in a direction shown by the arrow marked “a” in FIG. 1. The transfer belt 21 is wound to expand between a drive roller 91 rotated by a motor in the direction shown by the arrow marked “a,” and a drive roller 92 separated from the drive roller 91 by a predetermined distance rotating at a constant speed in the direction of the arrow marked “a.” The image forming portions 10y, 10m, 10c and 10k are arranged in series along a transfer direction of the transfer belt 21.

The image forming portions 10y, 10m, 10c and 10k include photosensitive drums 61y, 61m, 61c and 61k, respectively, as image carriers. Outer peripheral faces of the drums are formed in the same direction at respective positions in contact with the transfer belt 21. The photosensitive drums 61y, 61m, 61c and 61k are rotated at a predetermined speed by a motor.

The photosensitive drums 61y, 61m and 61c and 61k are arranged such that their axis lines are respectively disposed at equal intervals and are arranged such that the axis lines are orthogonal to the direction that the images are transferred by the transfer belt 21. The directions of the axis lines of the photosensitive drums 61y, 61m, 61c and 61k are defined as main scanning directions (second direction). The rotational directions of the photosensitive drums 61y, 61m, 61c and 61k, which correspond to a rotational direction of the transfer belt 21 (the arrow marked “a”), are defined as subscanning directions (first direction).

Electricity charging apparatus 62y, 62m, 62c and 62k, electricity removing apparatus 63y, 63m, 63c and 63k and developing rollers 64y, 64m, 64c and 64k are all extended in the main scanning direction. Lower agitating rollers 67y, 67m, 67c and 67k, upper agitating rollers 68y, 68m, 68c and 68k, transcribing apparatus 93y, 93m, 93c and 93k, and cleaning blades 65y, 65m, 65c and 65k also extend in the main scanning direction. Discharged toner recovery screws 66y, 66m, 66c and 66k are arranged successively along the rotational direction of the photosensitive drums 61y, 61m, 61c and 61k.

Transcribing apparatus 93y, 93m, 93c and 93k are arranged at positions sandwiching the transfer belt 21 between them. Corresponding ones of the photosensitive drums 61y, 61m, 61c and 61k are arranged on an inner side of the transfer belt. Further, exposure points by an exposure apparatus 50 are respectively formed on the outer peripheral faces of the photosensitive drums 61y, 61m, 61c and 61k between the electricity charging apparatus 62y, 62m, 62c and 62k and developing rollers 64y, 64m, 64c and 64k.

Sheet cassettes 22a and 22b are arranged on a lower side of the transfer mechanism 20 and contain sheets of the sheet P as image forming media for transcribing images formed by the respective image forming portions 10y, 10m, 10c and 10k. Pickup rollers 23a and 23b are arranged at end portions on one side of the sheet cassettes 22a and 22b and on sides thereof proximate to the drive roller 92. Pickup rollers 23a and 23b pick up the sheet P contained in the sheet cassettes 22a and 22b sheet by sheet from topmost portions of the sheets. A register roller 24 is arranged between the pickup rollers 23a and 23b and the drive roller 92. The register roller 24 matches a front end of the sheet P picked from the sheet cassette 22a or 22b and a front end of a toner image formed at the photosensitive drum 61y of the image forming portion 10y. Toner images formed at the other photosensitive drums 61y, 61m and 61c are supplied to respective transcribing positions in conformity with transfer timings of the sheet P transferred on the transfer belt 21.

An adsorbing roller 26 is arranged between the register roller 24 and the first image forming portion 10y, at a vicinity of the drive roller 92, such as above an outer periphery of the drive roller 92 substantially pinching the transfer belt 21. The adsorbing roller 26 provides electrostatic adsorbing force to the sheet P transferred at predetermined timings via the register roller 24. The axis line of the adsorbing roller 26 and the axis line of the drive roller 92 are set to be in parallel with each other.

A positional shift sensor 96 is arranged at one end of the transfer belt 21, and at a vicinity of the drive roller 91, such as above an outer periphery of the drive roller 91 substantially pinching the transfer belt 21. The positional shift sensor 96 detects a position of the image formed on the transfer belt 21. The positional shift sensor 96 may be implemented, for example, as a transmitting type or a reflecting type optical sensor.

A transfer belt cleaning apparatus 95 is arranged on an outer periphery of the drive roller 91 and above the transfer belt 21 on the downstream side of the positional shift sensor 96. The transfer belt cleaning apparatus 95 removes toner or paper dust off the sheet P adhered onto the transfer belt 21.

A fixing apparatus 80 is arranged to receive the sheet P when it detaches from the transfer belt 21 and transfers the sheet P further. The fixing apparatus 80 fixes the toner image on the sheet P by melting the toner image transcribed onto the sheet P by heating the sheet P to a predetermined temperature. The fixing apparatus 80 includes a pair of heat rollers 81, oil coating rollers 82 and 83, a web winding roller 84, a web roller 85 and a web pressing roller 86. After the toner formed on the sheet P is fixed to the sheet, the sheet P is discharged by a paper discharge roller pair 87.

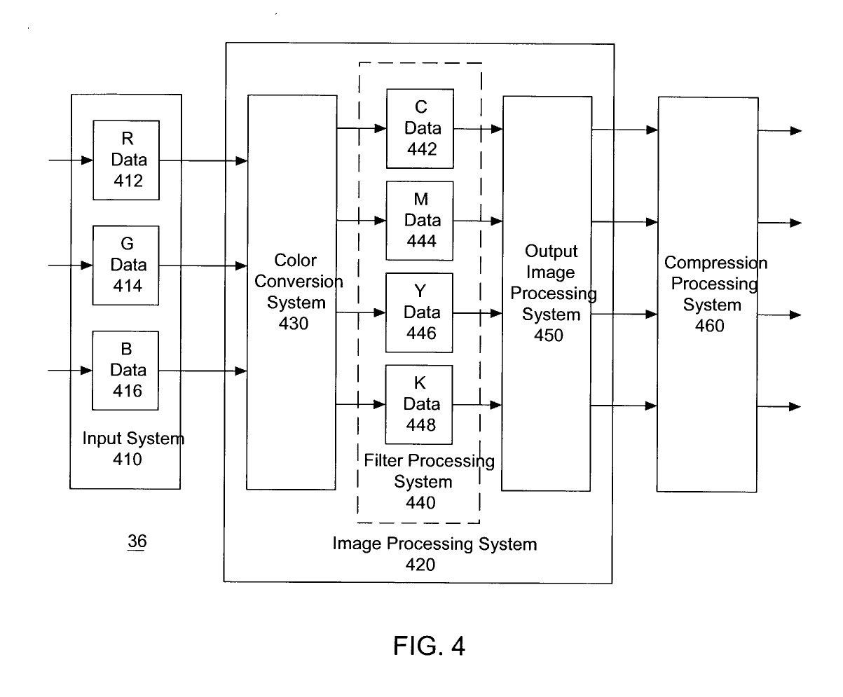

The exposure apparatus 50 forms electrostatic latent images subjected to color decomposition on the outer peripheral faces of the photosensitive drums 61y, 61m, 61c and 61k. The exposure apparatus is provided with a semiconductor laser oscillator 60 controlled to emit light based on image data (Y, M, C, K) for respective colors subjected to color decomposition by an image processing apparatus 36 (see FIG. 4).

On an optical path of the semiconductor laser oscillator 60, there are successively provided a polygonal mirror 51 rotated by a polygonal motor 54 for reflecting and scanning a laser beam light and fθ lenses 52 and 53 for correcting and focusing a focal point of the laser beam light reflected via the polygonal mirror 51. First folding mirrors 55y, 55m, 55c and 55k are arranged between the fθ lens 53 and the photosensitive drums 61y, 61m, 61c and 61k. The first folding mirrors 55y, 55m, 55c and 55k fold or reflect the laser beam light of respective colors that have passed through the fθ lens 53 toward the exposure positions of the photosensitive drums 61y, 61m, 61c and 61k. Second and third folding mirrors 56y, 56m, 56c and 57y, 57m and 57c further fold or reflect the laser beam light folded by the first folding mirrors 55y, 55m and 55c. The laser beam light for black is folded or reflected by the first folding mirror 55k and thereafter guided onto the photosensitive drum 61k without detouring other mirrors.

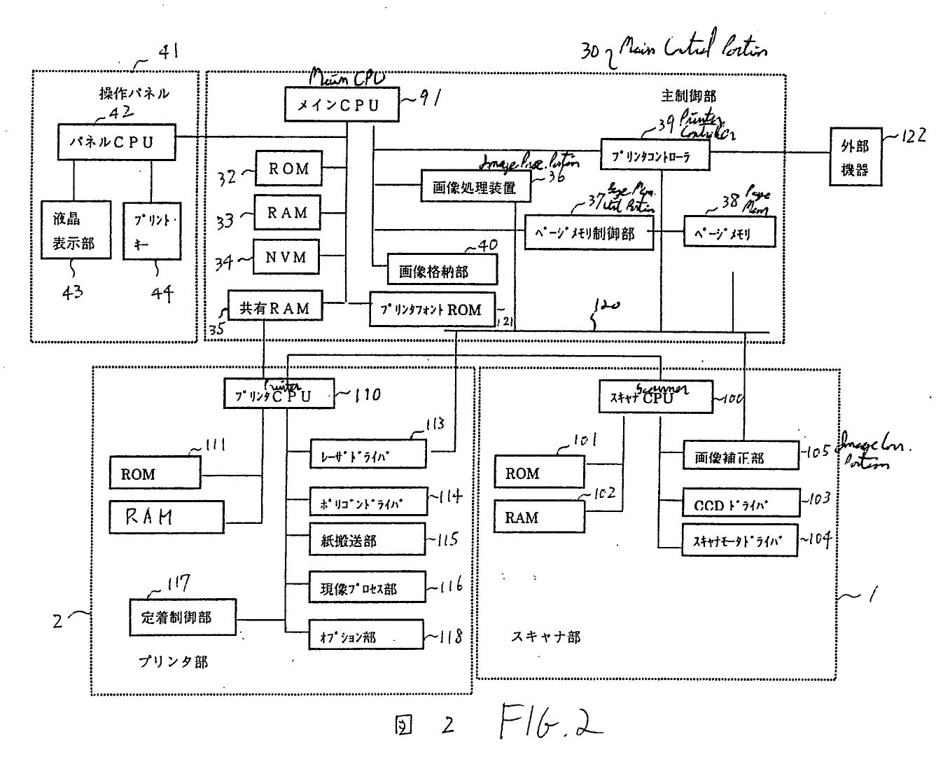

FIG. 2 shows a block diagram of a control system for the image forming apparatus of FIG. 1. In FIG. 2, the control system includes three CPUs: a main CPU (Central Processing Unit) 91 in a main control portion 30; a scanner CPU 100 of the color scanner portion 1; and a printer CPU 110 of the color printer portion 2. The main CPU 91 carries out bidirectional communication with the printer CPU 110 via a common ROM (Random Access Memory) 35. The main CPU 91 issues operation instructions, and the printer CPU 110 returns state statuses. The printer CPU 110 and the scanner CPU 100 carry out serial communication. The printer CPU 110 issues operation instructions, and the scanner CPU 100 returns state statuses.

An operation panel 41 includes a liquid crystal display portion 43, various operation keys 44 and a panel CPU 42. The operation panel 41 is connected to the main CPU 91. The main control portion 30 includes the main CPU 91, a ROM (Read Only Memory) 32, a RAM 33, an NVRAM 34, the common RAM 35, the image processing apparatus 36, a page memory control portion 37, a page memory 38, a printer controller 39 and a printer font ROM 121.

The main CPU 91 controls the main control portion 30. The ROM 32 is stored with control programs. The RAM 33 is for temporarily storing data. The NVRAM (Nonvolatile Random Access Memory: Nonvolatile RAM) 34 is a memory backed up with a battery (not illustrated) for holding stored data even when a power source is cut. The common RAM 35 is for carrying out bidirectional communication between the main CPU 91 and the printer CPU 110.

The page memory control portion 37 stores and reads image information to and from the page memory 38. The page memory 38 includes an area capable of storing a plurality of pages of image information and is formed to be able to store data compressed with image information from the color scanner portion 1 for each compressed page.

The printer font ROM 121 is stored with font data in correspondence with the print data. The printer controller 39 develops printer data from an outside apparatus 122, such as a personal computer, into image data. The printer controller uses the font data stored in the printer font ROM 121 at a resolution in accordance with data indicating a resolution included in the printer data.

The color scanner portion 1 includes the scanner CPU 100, which controls the color scanner portion 1. The color scanner portion also includes a ROM 101 stored with control programs, a RAM 102 for storing data, a CCD driver 103 for driving the color image sensor 15, a scanning motor driver 104 for controlling rotation of a scanning motor and moving the first carriage 8, and an image correcting portion 105. The image correcting portion 105 includes an A/D conversion circuit for converting analog signals of R, G and B outputted from the color image sensor 15 respectively into digital signals, a shading correction circuit for correcting a dispersion in a threshold level with respect to an output signal from the color image sensor 15 caused by a variation in the color image sensor 15 or surrounding temperature change, and a line memory for temporarily storing the digital signals subjected to shading correction from the shading correction circuit.

The color printer portion 2 includes the printer CPU 110, which controls the color printer portion 2. The color printer portion 2 also includes a ROM 111 stored with control programs, a RAM 112 for storing data, the laser driver 113 for driving the semiconductor laser oscillator 60, a polygonal motor driver 114 for driving the polygonal motor 54 of the exposure apparatus 50, and a transfer control portion 115 for controlling the transfer of the sheet P by the transfer mechanism 20.

The color printer portion 2 further includes a process control portion 116, a fixing control portion 117 for controlling the fixing apparatus 80, and an option control portion 118 for controlling options. The process control portion 116 controls processes for charging electricity, developing and transcribing by use of the electricity charging apparatus, the developing roller and the transcribing apparatus. The image processing portion 36, the page memory 38, the printer controller 39, the image correcting portion 105 and the laser driver 113 are connected to each other by an image data bus 120.

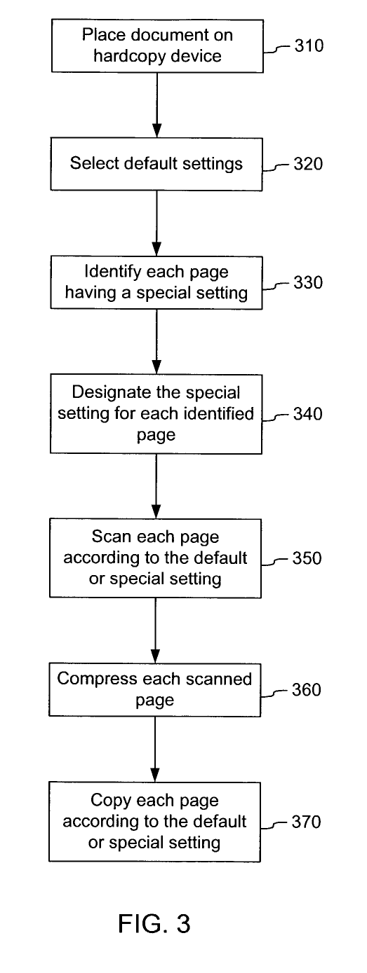

FIG. 3 is a flow diagram for a control process consistent with the present invention. The control process can be to copy a document, scan a document, compress a scanned document, a combination of these functions, or some other function that can be performed by a hardcopy device, such as a digital copier or multi-function peripheral (MFP). As shown in FIG. 3, a user first places a document on the hardcopy device (step 310). The document may include one or more pages. Each page of the document may be the same size or be of different sizes, such as 8.5″×11″ or A4 sized paper. The content on the pages of the document may include text, figures, images or other graphics. In addition, the content on the pages of the document may be in color, black and white or some combination thereof.

After placing the document on the hardcopy device, the user selects default settings (step 320). The default settings define how each of the pages of the document are to be scanned and/or copied when a page is not designated for a special setting. There are one or more settings that can be selected by the user for the default settings. The settings that may be selected by the user include, for example, the paper size, any enlargement or diminution of the image size, the image density or darkness level, color versus black and white, or copy mode, such as text or photograph. Other settings known in the art for scanning and/or copying a document may also be selected by the user. To select the default settings, the user may depress one or more buttons on the hardcopy device or use a touch display having one or more menus or screens through which the user designates the default settings.

Instead of specifying the default settings, the user may use the default settings of the hardcopy device. The hardcopy device may have default settings for each of the possible settings of the hardcopy device without the user specifying them. For example, the hardcopy device may have a default paper size to scan and/or copy the document.

In addition to selecting the default settings, the user identifies each page having a special setting (step 330). A special setting is a setting identified for the user for a particular page of the document that is different than the default setting. The user may identify one or more pages as having special settings. To identify the page, the user may use an entry component, such as a touch pad interface or keypad, located on the hardcopy device. For example, if the document has five pages, the user may identify pages two and four as having special settings.

For each page identified as having a special setting, the user designates the specific settings for the special setting (step 340). Each page identified by the user as having a special setting may have its own unique setting or the same special setting as the other identified pages. The settings designated by the user for the special setting may be any of the settings available for the default settings, described above, including the paper size, any enlargement or diminution of the image size, the image density or darkness level, color versus black and white, or copy mode, such as text or photograph. To select the special settings, the user may depress one or more buttons on the hardcopy device or use a touch display having one or more menus or screens through which the user designates the special settings.

Based on the designated default and special settings for the pages of the document, each page of the document is scanned (step 350). Each page that is not identified as a page with a special setting is scanned according to the default setting. Each page having a special setting is scanned according to the special setting designated for that page. With the special settings for one or more pages of the document, it is possible to scan and/or copy the pages of the document with different settings. In addition, when a plurality of pages of a document are inputted into the hardcopy device, it is possible to scan and/or copy the pages with various settings using an ADF and without placing pages having different settings on the hardcopy device page by page.

By designating the special settings for one or more pages of the document, it is also possible to avoid some of the inefficiency of using an ACS process for discriminating between color and monochrome pages of the document. The ACS process requires a prescan and determination as to whether a page is in color or monochrome before the scanned image is processed. As a result, the ACS process can be inefficient if only a couple of pages out of many pages of the document are, for example, in color. With the special settings, the couple of pages that are in color can be designated by the special settings, which avoids the need for the ACS process and the associated prescanning and can amount to a considerable increase in efficiency.

The scanning of each page can be performed by the image processing apparatus 36 of FIG. 2. FIG. 4 is a block diagram of the image processing apparatus of FIG. 2 for processing the scanned image. The image processing apparatus 36 includes an input system 410, which receives image data from the page memory 38 that stores the scanned image of a page of the document. The image processing apparatus 36 also includes an image processing system 420, which executes image processing on a signal output from the input system 410, and a compression processing system 460, which executes compression processing when the processed image data is brought into a file.

The image processing system 420 includes a color conversion system 430, a filter processing system 440 and an output image processing system 450. The color conversion system 430 converts RGB data 412-416 output from the input system 410 into cyan, magenta, yellow and black (hereinafter, Y data 446, M data 444, C data 442, K data 448). The filter processing system 440 processes the YMCK data 442-448 for enlargement, contraction, matrix removal, noise removal, edge emphasis and other settings. The output image processing system 450 executes r correction corresponding to the gray scale processing of the image and output devices. The processing of the image data carried out by the image processing system 420 is performed in accordance with the default and special settings for the respective pages of the document previously set by the user and other processing information.

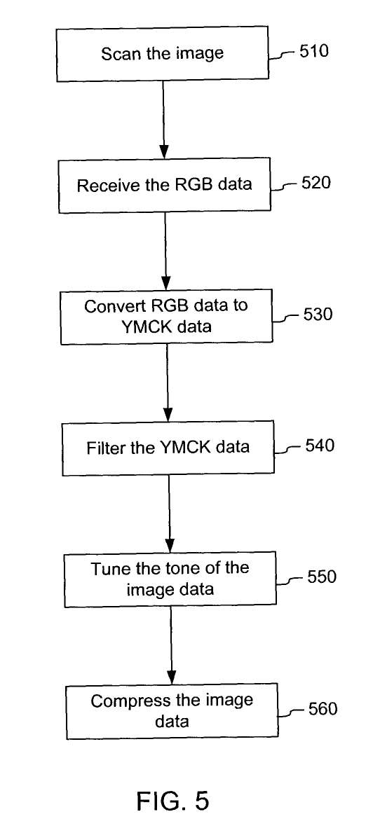

FIG. 5 is a flow diagram of an image process for the image processing apparatus of FIG. 4. As shown in FIG. 5, the image on the page of a document is scanned by the hardcopy device (step 510). The scanned image is received as RGB data by the image processing apparatus 36 (step 520). More particularly, the RGB data is received by the input system 410 of the image processing apparatus 36.

The RGB data received by the image processing apparatus 36 is converted from RGB data into YMCK data (step 530). The conversion of the RGB data into the YMCK data is performed by the color conversion system 430. The YMCK data is then filtered (step 540). The YMCK data is filtered by the filter processing system 440. The filtering of the YMCK data removes a moire of a picture and improves the sharpness of a picture.

In addition to the filtering, the tone of the YMCK data is tuned (step 550). The tuning of the tone of the YMCK data is performed by the output image processing system 450. Tuning the tone of the image data tunes the gradation characteristic finely so as to prevent an occurrence of a dark area collapsing and to improve reproduction of highlight portions. The image data output from the output image processing system 450 may then be compressed by the compression processing system 460 (step 560). The compression of the image data will be described in more detail below.

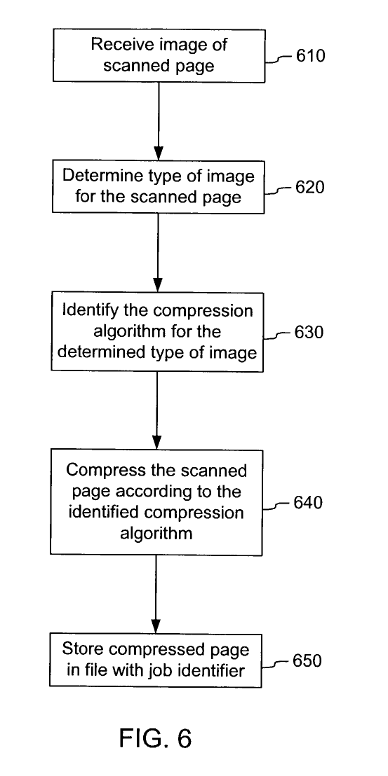

Returning to FIG. 3, after scanning, each page may be compressed (step 360). FIG. 6 is a flow diagram for compressing scanned images consistent with the present invention. As shown in FIG. 6, the compression process receives the image data of the scanned page (step 610). As described above, the compression processing system 460 of the image processing apparatus 36 receives the image data, preferably after undergoing image processing by the image processing system 420, although it is possible to perform the compression process on the scanned image data without undergoing such image processing.

For each scanned page, the type of image is determined (step 620). The image type may be, for example, a photographic image or a text image. Alternatively, the image type may be a color image or a black and white image. It is also possible for the image type to be some combination of these types, such as a black and white text image. Other image types may also be determined. The image type may be determined from the default setting or special setting associated with the particular scanned page.

Based on the determined type of image, a compression algorithm is identified (step 630). Each image type may have a different compression algorithm. For example, a black and white image may be compressed with a first type of compression algorithm, and a color image may be compressed with a second type of compression algorithm different from the first type of compression algorithm. Each compression algorithm may be an MPEG or other type of image compression algorithm.

For each image type, the identified compression algorithm is preferably optimized for that image type. This optimization may reduce the amount of space required for storing the compressed images with respect to the amount of required storage space when compressing each image type with the same compression algorithm. For example, a compression algorithm optimized for a color image may be less efficient and require more storage space when compressing a black and white image. Conversely, a compression algorithm optimized for the black and white image may be less efficient and require more storage space when compressing the color image.

The scanned page is then compressed using the identified compression algorithm (step 640). When the compression algorithms are optimized for the image type, the compression of the scanned page is optimized for that image type. As described above, the compression algorithms may be optimized to reduce the amount of space required to store the compressed image. Alternatively, the compression algorithms may be optimized to reduce the amount of time to perform the compression for the particular image type.

After compressing the image data for the scanned page, the compressed image data is stored in a file with an identifier (step 650). The compressed image data for each scanned page is stored in a separate file from each other scanned page. When a document is scanned having more than one page, then the compressed image data for the document is stored in more than one file. The number of files corresponds to the number of pages in the document.

Each file includes an identifier to link the file to the other files corresponding to each of the pages of the document being scanned. The identifier may be part of the file name for each file associated with the document. Alternatively, each of the files may be stored in a folder, where the name of the folder includes the identifier to link the files in the folder to the scanned document. The identifier may also be stored in the file itself. The identifier may be provided by the user, who inputs the identifier through an interface of the hardcopy device. Alternatively, the identifier may be a job number automatically associated with each scan job.

Returning to FIG. 3, in addition to compressing each scanned page, the hardcopy device can generate a copy of each page according to the default or special setting for that page (step 370). Each page that is not identified as a page with a special setting is copied according to the default setting. Each page having a special setting is copied according to the special setting designated for that page. With the special settings for one or more pages of the document, it is possible to copy the pages of the document with different settings.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for processing a plurality of pages, comprising:
receiving a selection of default settings for scanning the plurality of pages;
identifying at least one of the plurality of pages for special settings;
designating the special settings for each of the at least one identified pages; and
scanning each of the at least one identified pages according to the designated special settings and scanning each of the plurality of pages other than the at least one identified pages according to the default settings.

2. A method according to claim 1, further comprising compressing each of the scanned pages with a compression algorithm in accordance with the special settings or default settings for that scanned page.

3. A method according to claim 2, wherein the compression algorithm is different for the special settings and the default settings.

4. A method according to claim 2, further comprising using a first compression algorithm if the special or default settings indicate the page is in color and using a second compression algorithm different from the first compression algorithm if the special or default settings indicate the page is in black and white.

5. A method according to claim 1, further comprising saving each of the compressed pages in a separate file.

6. A method according to claim 5, further comprising storing each separate file in a common folder.

7. A method according to claim 5, further comprising including a common identifier for each of the separate files.

8. A method according to claim 1, further comprising copying each of the at least one identified pages according to the designated special settings and copying each of the plurality of pages other than the at least one identified pages according to the default settings.

9. A computer readable medium operable on a computer system for processing a plurality of pages input on a hardcopy device, the computer readable medium configured to:
receive a selection of default settings for scanning the plurality of pages;
identify at least one of the plurality of pages for special settings;
designate the special settings for each of the at least one identified pages; and
scan each of the at least one identified pages according to the designated special settings and scanning each of the plurality of pages other than the at least one identified pages according to the default settings.

10. A computer readable medium according to claim 9, further configured to compress each of the scanned pages with a compression algorithm in accordance with the special settings or default settings for that scanned page.

11. A computer readable medium according to claim 10, wherein the compression algorithm is different for the special settings and the default settings.

12. A computer readable medium according to claim 10, further configured to use a first compression algorithm if the special or default settings indicate the page is in color and use a second compression algorithm different from the first compression algorithm if the special or default settings indicate the page is in black and white.

13. A computer readable medium according to claim 9, further configured to save each of the compressed pages in a separate file.

14. A computer readable medium according to claim 13, further configured to store each separate file in a common folder.

15. A computer readable medium according to claim 13, further configured to include a common identifier for each of the separate files.

16. A computer readable medium according to claim 9, further configured to copy each of the at least one identified pages according to the designated special settings and copying each of the plurality of pages other than the at least one identified pages according to the default settings.

17. A hardcopy device for processing a plurality of pages input on the hardcopy device, the hardcopy device comprising:
a processor; and
a memory, coupled to the processor, comprising a plurality of instructions executed by the processor, the plurality of instructions configured to:
receive a selection of default settings for scanning the plurality of pages;
identify at least one of the plurality of pages for special settings;
designate the special settings for each of the at least one identified pages; and
scan each of the at least one identified pages according to the designated special settings and scanning each of the plurality of pages other than the at least one identified pages according to the default settings.

18. A hardcopy device according to claim 17, the memory further comprising an instruction configured to compress each of the scanned pages with a compression algorithm in accordance with the special settings or default settings for that scanned page.

19. A hardcopy device according to claim 18, wherein the compression algorithm is different for the special settings and the default settings.

20. A hardcopy device according to claim 18, the memory further comprising an instruction configured to use a first compression algorithm if the special or default settings indicate the page is in color and use a second compression algorithm different from the first compression algorithm if the special or default settings indicate the page is in black and white.

21. A hardcopy device according to claim 17, the memory further comprising an instruction configured to save each of the compressed pages in a separate file.

22. A hardcopy device according to claim 21, the memory further comprising an instruction configured to store each separate file in a common folder.

23. A hardcopy device according to claim 21, the memory further comprising an instruction configured to include a common identifier for each of the separate files.

24. A hardcopy device according to claim 17, the memory further comprising an instruction configured to copy each of the at least one identified pages according to the designated special settings and copying each of the plurality of pages other than the at least one identified pages according to the default settings.
